(19) United States
(12) Patent Application Publication
(10) Pub. No.: US 2015/0066372 A1
(43) Pub. Date: Mar. 5, 2015

(54) METHOD AND SYSTEM FOR ANALYZING AND PROCESSING CONTINUED FLOW DATA IN WELL TESTING DATA

(71) Applicant: IDS NEW TECHNOLOGY CO., LTD., Beijing (CN)

(72) Inventors: Qinglan Shi, Beijing (CN); Rong Chen, Beijing (CN); Yili Ling, Beijing (CN); Bin Zhang, Beijing (CN); Hua Zhao, Beijing (CN)

(21) Appl. No.: 14/536,528

(22) Filed: Nov. 7, 2014

Related U.S. Application Data
(63) Continuation of application No. PCT/CN2013/080791, filed on Aug. 5, 2013.

(30) Foreign Application Priority Data
Aug. 9, 2012 (CN) 201210281796.3

(51) Int. Cl. E21B 47/10; G01N 15/08

(52) U.S. Cl. CPC E21B 47/10; G01N 15/0826
USPC 702/12

(57) ABSTRACT

Methods and systems analyze continued flow data in well testing data. Embodiments can determine relations between an isochron rate and influence factors under pre-detected lithologic conditions, acquire relational data between the isochron rate and the lithology of a reservoir, the structure of the reservoir, and fluid properties; establish a mathematical model of the isochron rate; collect bottom hole pressure at different collection moments respectively during the reservoir well testing process; acquire a measured isochron rate curve between the isochron rate Vₚ and the constant duration t; select well testing interpretation model parameters; calculate a model isochron rate Vₚ′ at different moments according to the mathematical model of the isochron rate and the selected well testing interpretation model parameters; acquire a model isochron rate curve between Vₚ′ and the model constant duration t′; and fit the model isochron rate curve and the measured isochron rate curve to acquire reservoir characteristic parameters.

### CROSS-REFERENCES TO RELATED APPLICATIONS

This application is a continuation application of PCT application PCT/CN2013/080791 entitled “Analysis Processing Method and System for Afterflow Data in Well Test Data,” filed on Aug. 5, 2013, which claims priority to Chinese Patent Application No. 201210281796.3, filed on Aug. 9, 2012, which are herein incorporated by reference in their entirety for all purposes.

### FIELD

The present disclosure relates to technologies for evaluating, analyzing and processing well testing data during exploration and development of oil fields, and particularly to a method and a system for analyzing and processing continued flow data in well testing data.

### BACKGROUND

Well testing (also known as testing) is an important means for acquiring reservoir characteristic information in time and quantitatively evaluating and analyzing hydrocarbon reservoirs during exploration and development of oil fields. The results of the well testing are reservoir characteristic parameter data required by reserve calculation of the oil fields, construction of reservoir models, formulation of exploration schemes and development schemes and optimization of measures.

Well testing interpretation is a key link between formation testing and well testing data evaluation, analysis and processing. All data acquired by the well testing technology should be applicable to well testing interpretation theories and methods. Acquiring reservoir characteristic parameters (i.e., all characteristic parameters of a reservoir) by comprehensively evaluating, analyzing and processing well testing data is an interpretation evaluation technology based on a linear flow theory. The development history of the well testing interpretation theories and methods roughly undergoes the following three stages: a manual interpretation era centered in a Horner interpretation method and a Glinka ascended chart interpretation method which are based on a pressure drawdown interpretation theory, a computer model interpretation stage based on a Horner interpretation theory and the pressure drawdown interpretation theory, and a multi-model interpretation stage based on an overlay interpretation theory and a modern well testing interpretation theory.

During the whole development process of applying the computer technology into well testing interpretation, a developing subject is to establish a professional technical application system combining latest well testing interpretation theoretical research results with the computer technology, thereby forming well testing interpretation theories and methods at different times and performing high-precision analysis and processing on pressure drawdown data or pressure buildup data. However, during the whole development process, all the well testing interpretation theories and methods are based on a Darcy percolation theory and a radial flow theory; furthermore, based on these theories, multiple well testing interpretation charts specific to different reservoir characteristics are formed by establishing various physical models and mathematical models.

With the continuous improvement of well testing technologies, measuring instruments and interpretation theories and the rapid development of the computer technology, there are more and more technical methods for well testing, the precision of acquired test data becomes higher, and the scope of models for evaluation and analysis of well testing interpretation becomes wider, so that a system of modern well testing theories and methods using steady well testing and transient well testing as core contents is established. However, for whatever well testing technology, its theoretical basis still is the basic theory system of the Darcy percolation theory and the radial flow theory. During the operation of analyzing and processing test data and acquiring reservoir characteristic parameters, regardless of a semilog interpretation method, an improved Mixture Of Distribution Hypothesis (hereinafter referred to as MDH) method or a modern well testing interpretation method, it is mainly based on research on change factures of pressure under radial flow conditions, then basic models of different reservoirs are established according to the research on the change factures of pressure, and the pressure, permeability, external disturbance, damage degree and other characteristic parameters of the tested reservoirs are acquired by comparatively analyzing the basic models and the actually measured data. Due to the restriction of assumptions from the basic theory and modeling, the basis of the application of the above methods is pressure data acquisition in order to achieve the elimination of wellbore and reservoir continued flow interference based morphology, radial flow, to achieve the solution. However, in practical application, as the exploration and development of oil and gas develops to low permeability reservoirs and extra-low permeability reservoirs, on the one hand, the application of a model based on the radial flow theory is restricted due to the influence of non-Darcy percolation, and the error of well testing interpretation increases; on the other hand, due to unreasonable testing time, the physical property in low permeability of reservoirs and other reasons, outstanding problems of poor reservoir flow conductivity, low production yield, slow pressure conduction and the like are caused, so that well testing data under radial flow conditions cannot be measured during testing, and it is extremely difficult to acquire data which meets the requirements of the radial flow well testing interpretation theory. Particularly, during testing of extra-low permeability reservoirs, although the quality of testing data may be improved to a certain extent by lots of measures of improving technologies, optimizing testing time and so on, the amount of acquired testing data meeting the requirements of the radial flow well testing interpretation theory is still very low, and lots of testing data cannot be utilized to perform reservoir evaluation effectively, thereby causing the loss of first-hand data of reservoir evaluation and analysis, lowering the pertinence of exploration and development as well as reservoir improvement, greatly increasing the cost of testing as well as exploration and development, and causing the outstanding problems of low yield and high investment.

During well testing, in stages, the actually measured pressure data is classified into four parts, i.e., wellbore storage data, continued flow data (also known as transition data), radial flow data and later data in sequence from front to back. Due to poor physical properties of reservoirs or unreasonable distribution of actual measurement time, lots of test data cannot reach the required conditions of the radial flow well testing interpretation theory during the well testing process of low permeability reservoirs and ultra-low permeability reservoirs, and acquired data is in the continued flow stage and is generally called as continued flow data, so that conventional radial flow well testing interpretation theories and methods cannot be used for evaluating and analyzing the tested continued flow data, further, reservoir characteristic parameters cannot be acquired through the well testing data and the evaluation and analysis of the data, and the well testing data loses application value. Because the results of well testing interpretation evaluation cannot be acquired, the reservoir cannot be evaluated and analyzed quantitatively and qualitatively, so that there is a lack of the data for comprehensive analysis on exploration and development of oil fields, and a difficulty is caused for the formulation of an exploration and development scheme of oil fields. Particularly, after the exploration and development to dense-lithology reservoirs have been carried out, in a practical formation testing process, the reservoir percolation capability is low, the pressure conduction performance is poor and it is extremely difficult to acquire radial flow data no matter what testing methods and remedial measures are used in the well testing technology during the operation of evaluation and analysis on oil field reservoirs, so that it is required to take not only lots of cost for testing but also long testing time, and majority of reservoirs still cannot meet the requirements of acquiring radial flow well testing data.

Therefore, during the implementation of the present disclosure, the inventor (inventors) finds at least the following problems in the prior art:

The well testing interpretation theories and methods based on the radial low percolation theory cannot be used for evaluating and analyzing continued flow data or forming corresponding theoretical basis and evaluation and analysis methods; during the long-term application research, researchers adopt methods such as the production history of overlay analysis, the mechanics correction method, the early time continued flow time correction method and the mathematical model of single well and also implement the operations of the subdivision of flow, the shut-in time correction, the production time compensation and the like, but all the methods and operations cannot do without performing certain empirical correction or mechanics correction on flow data in order to analyze and process the data, which does not meet the radial flow theory, through the radial flow theory after the data is corrected; however, because there are some problems in the application of the theoretical basis and the established interpretation method is complicated and has large limitation, the interpretation method can only be used for performing reference analysis in empirically comparative study and character analysis and evaluation, and cannot meet the requirements of the evaluation and analysis of well testing data and the requirements of oil field application.

Hence, the radial flow well testing theories and methods cannot be used for processing, evaluating and analyzing the continued flow data systematically and comprehensively, and the loss of characteristic parameter data of reservoirs obtained by means of well testing has become a primary factor restricting the exploration and development of oil fields. Meanwhile, with the continuous increase of dense lithology, fractured volcanics and other non-Darcy reservoirs, the precision of processing and evaluating by the radial flow well testing interpretation theories and methods is lowered and the difficulty of reservoir characteristic analysis increases because the percolation states of the non-Darcy reservoirs completely do not accord with the radial flow theory, and the evaluation and analysis of continued data and non-Darcy reservoirs have become the important content of technological breakthrough research at home and abroad in recent years.

### BRIEF SUMMARY

A technical problem to be solved by the embodiments of the present disclosure is to provide a method and system for analyzing and processing continued flow data in well testing data, which aim at analyzing and processing continued flow data in well testing data to acquire characteristic parameters of reservoirs and further to realize evaluation and analysis on non-Darcy reservoirs in the case of actually measured data not reaching radial flow conditions during well testing.

The embodiments of the present disclosure provide a method for analyzing and processing continued flow data in well testing data, including:

determining relations between an isochron rate and various influence factors under various pre-detected lithologic conditions, wherein the relations include a relation between the isochron rate and a percolation state, a relation between the isochron rate and permeability, a relation between the isochron rate and pollution, and a relation between the isochron rate and fracture channeling characteristics;

acquiring relational data between the isochron rate and the lithology of a reservoir, the structure of the reservoir and fluid properties according to the relations between the isochron rate and the various influence factors, and establishing a mathematical model of the isochron rate;

collecting bottom hole pressure at different collection moments during the reservoir well testing process, and acquiring a correspondence curve Vₚ˜t between the isochron rate Vₚ=(P₂−P₁)/(t₂−t₁) and a constant duration t=t₂−t₁ as an actually measured isochron rate curve, wherein P₂ and P₁ are pressure values collected at the end moment t₂ and the start moment t₁ of the constant duration t;

selecting well testing interpretation model parameters, calculating a model isochron rate Vₚ′ at different moments according to the mathematical model of the isochron rate and the selected well testing interpretation model parameters, and acquiring a correspondence curve Vₚ′˜t′ between Vₚ′ and the model constant duration t′=t₂′−t₁′ as a model isochron rate curve, wherein Vₚ′ is an isochron rate corresponding to the model constant duration t′ acquired according to the selected well testing interpretation model parameters under the mathematical model of the isochron rate; and

fitting the model isochron rate curve and the actually measured isochron rate curve to acquire reservoir characteristic parameters including permeability K and channeling time t_{c}.

The embodiments of the present disclosure provide a system for analyzing and processing continued flow data in well testing data, including:

a collection unit configured to collect bottom hole pressure at different collection moments during the reservoir well testing process;

a parameter selection unit configured to select well testing interpretation model parameters;

a storage unit configured to store a pre-established mathematical model of an isochron rate, wherein the mathematical model of the isochron rate is established on the basis of relational data between the isochron rate and the lithology of a reservoir, the structure of the reservoir and fluid properties, which is obtained according to relations between the isochron rate and various influence factors under various pre-detected lithologic conditions, and the relations comprise a relation between the isochron rate and a percolation state, a relation between the isochron rate and permeability, a relation between the isochron rate and pollution, and a relation between the isochron rate and fracture channeling characteristics;

a calculation unit configured to calculate a model isochron rate Vₚ′ at different moments according to the well testing interpretation model parameters selected by the parameter selection unit and the mathematical model of the isochron rate stored in the storage unit, wherein Vₚ′ is an isochron rate corresponding to the model constant duration t′ acquired according to the selected well testing interpretation model parameters under the mathematical model of the isochron rate;

an acquisition unit configured to acquire a correspondence curve Vₚ˜t between the isochron rate Vₚ=(P₂−P₁)/(t₂−t₁) and the constant duration t=t₂−t₁ as an actually measured isochron rate curve according to the bottom hole pressure collected at different collection moments by the collection unit, and to acquire a correspondence curve Vₚ′˜t′ between the model isochron rate Vₚ′ calculated by the calculation unit and the model constant duration t′=t₂′−t₁′ as a model isochron rate curve, wherein P₂ and P₁ are pressure values collected at the end moment t₂ and the start moment t₁ of the constant duration t; and

a fitting unit configured to fit the model isochron rate curve and the actually measured isochron rate curve acquired by the acquisition unit to acquire reservoir characteristic parameters including permeability K and channeling time t_{c}.

Based on the method and system for analyzing and processing continued flow data in well testing data provided by the embodiments of the present disclosure, on the basis of researching the change rate of pressure of the reservoir within equal time, the relations between the isochron rate and various influence factors under various pre-detected lithologic conditions include a relation between the isochron rate and a percolation state, a relation between the isochron rate and permeability, a relation between the isochron rate and pollution, and a relation between the isochron rate and fracture channeling characteristics; relational data between the isochron rate and the lithology of a reservoir, the structure of the reservoir and fluid properties is acquired according to the relations between the isochron rate and various influence factors, and a mathematical model of the isochron rate is established. Based on isochron rate interpretation theories and methods, when acquired pressure buildup or pressure drawdown data does not reach the conditions of a stable radial flow state after the wellbore reservoir stage is ended in the well testing process, bottom hole pressure at different collection times is collected respectively after the wellbore reservoir stage is ended, an actually measured isochron rate curve between the isochron rate Vₚ and the constant duration t is acquired, a model isochron rate Vₚ′ at different moments is calculated according to the pre-established mathematical model of the isochron rate and the selected well testing interpretation model parameters, a model isochron rate curve indicating the correspondence between the isochron rate Vₚ′ and the model constant duration t′ is acquired, and then, the model isochron rate curve and the actually measured isochron rate curve are fitted to acquire reservoir characteristic parameters including permeability K and channeling time t_{c}, so that the method and system realize the analysis and processing on the continued flow data, may be applied to comprehensive analysis on percolation characteristics of reservoirs within a testing radius, realize the interpretation process of the continued flow data to acquire characteristic parameters of the reservoirs, achieve the purpose of analysis and process similar to those of the radial flow data, and realize the evaluation and analysis on non-Darcy flow reservoirs. The embodiments of the present disclosure provide a novel continued flow interpretation theory and method for evaluating and analyzing continued flow data, and a novel interpretation theory and method taking the isochron rate during pressure conduction as an analysis object.

The technical solutions of the present disclosure will be further described as below in details with reference to the accompanying drawings and embodiments.

### BRIEF DESCRIPTION OF THE DRAWINGS

To describe the technical solutions in the embodiments of the present disclosure or in the prior art more clearly, the accompanying drawings to be used for describing the embodiments or the prior art will be briefly introduced as below. Apparently, the accompanying drawings in the following description show merely some embodiments of the present disclosure, and a person of ordinary skill in the art may still derive other drawings from these accompanying drawings without creative efforts.

FIG. 1 is a flow diagram of an embodiment of a method for analyzing and processing continued flow data in well testing data according to the present disclosure.

FIG. 2 is a schematic diagram of a relation between an isochron rate and lithology according to the embodiment of the present disclosure.

FIG. 3 is a schematic diagram of a relation between the isochron rate and permeability according to the embodiment of the present disclosure.

FIG. 4 is a schematic diagram of a relation between the isochron rate and pollution characteristics according to the embodiment of the present disclosure.

FIG. 5 is a schematic diagram of a relation between the isochron rate and fracture interference of finite conductivity according to the embodiment of the present disclosure.

FIG. 6 is a schematic diagram of a relation between the isochron rate and fracture interference of infinite conductivity according to the embodiment of the present disclosure.

FIG. 7 is a flow diagram of another embodiment of a method for analyzing and processing continued flow data in well testing data according to the present disclosure.

FIG. 8 is a specific example of a curve Vₚ˜t according to the embodiment of the present disclosure.

FIG. 9 is a specific example of a first curve graph according to the embodiment of the present disclosure.

FIG. 10 is a specific example of a second curve graph according to the embodiment of the present disclosure.

FIG. 11 is a specific example of an actually measured curve V˜t according to the embodiment of the present disclosure.

FIG. 12 is a structure diagram of an embodiment of a system for analyzing and processing continued flow data in well testing data according to the present disclosure.

FIG. 13 is a structure diagram of another embodiment of a system for analyzing and processing continued flow data in well testing data according to the present disclosure.

### DETAILED DESCRIPTION

The technical solutions in the embodiments of the present disclosure will be described clearly and completely with reference to the drawings in the embodiments of the present disclosure. Apparently, the described embodiments merely are a part of but not all of the embodiments of the present disclosure. All other embodiments made, based on the embodiments of the present disclosure, by a person of ordinary skill in the art without creative efforts shall fall into the protection scope of the present disclosure.

At abroad, researches using a linear flow theory as a basic theory are early relatively, multiple percolation interpretation theories based on sandstone reservoirs, composite reservoirs and fractured reservoirs are formed early, and well testing interpretation software of American Information & Communication Technology (ICT) Company, a well testing system of Sconton, workbench well testing interpretation software of American SSI Company and so on are formed. During late development, American SSI Company continuously improves well testing interpretation theories and methods, and combines the requirements of production application with a computer network technology to research and develop a well testing network application system and an interpretation workstation integrated with well testing designs, well testing interpretation and reservoir digital models as a main body, so that the well testing interpretation technology develops rapidly from basic theory research to software development. At the beginning of 1990s, SaPhir well testing interpretation software of British EPS Company and French Kappa Company gradually occupies a large space in well testing interpretation through powerful research results of well testing basic theories and interpretation methods. Through continuous interpretation theory innovation and interpretation method personalization research, and in keeping with requirements of computer network technologies and oil field application, the well testing interpretation, well testing design and reservoir digital model technology are visualized and humanized, the number of well testing interpretation models is improved continuously, the models also develop from single homogeneous reservoirs to fractured reservoirs and composite reservoirs, the well types develop from single vertical wells to horizontal wells, inclined wells and multi-branch wells, and multiple complicated interpretation theoretical models and effect models of multiple types of boundary of gas wells, water wells, oil wells, heavy oil wells and the like are established, so that the well testing interpretation technology using a linear flow basic theory as the interpretation basis is allowed to develop to a relatively perfect level, and systematically guides the geological evaluation of oil exploration and development.

In recent years, with the increasing of nonlinear flow testing data and continued flow testing data, the research work focuses on Mckinley continued in-depth study and application of flow theory in order to establish digital well testing interpretation methods and further perfect research results. However, due to the influences of multiple factors, the technical research achieves little breakthrough, and the development and interpretation accuracy of an interpretation system of nonlinear flow data and continued flow data still cannot meet the requirements of high-accuracy analysis.

The early well testing interpretation work at home mainly depends on interpretation charts or system software imported from abroad. In 1980s, a testing company in North China firstly developed WTC well testing interpretation software by importing and studying the well testing interpretation software of American ICT Company, and with the rapid development of the computer technology, super-WITS well testing interpretation software is developed and becomes leading application software for well testing interpretation at home. With the complexity of types of reservoirs to be subjected to exploration and development and the progress of technologies at home, domestic software has large inapplicability due to single model and poor function, and is impacted by advanced well testing interpretation software from abroad quickly to withdraw from the application field. In view of the status of mainly low permeability oil fields and ultra-low permeability oil fields at home, the development of exploration toward low permeability volcanic reservoirs, the increasing of non-Darcy flow reservoirs and low permeability continued flow data, and totally different objects of exploration and development at home and abroad, the imported well testing interpretation software system and foreign technologies already cannot meet production demands at home, so that the research work of nonlinear flow basic theories is launched earlier, and the research on interpretation basic theories and methods stays ahead of the development of abroad. However, the research work of the well testing interpretation software system is based on the radial flow percolation theory, the well testing interpretation technology cannot achieve large breakthrough, the problems of limited application conditions, low accuracy and large application difficulty of analysis and evaluation are highlighted, and the problem on analysis and evaluation of continued flow data is not solved fundamentally.

At present, the method for evaluating and analyzing continued flow data based on the radial flow theory conforms to a theory formed by researching change rules of radial flow pressure, and a continued flow data analyzing method based on the theory is mainly used for performing overlay analysis on shut-in time or yield to make continued flow data form radial flow data by compensation transformation and then analyzing and processing the radial flow data by the radial flow theory. Due to the influences of the compensation transformation method and multiple unknown parameters, the establishment of systematic interpretation models and methods has high difficulty and large error. However, the embodiments of the present disclosure employ an isochron rate interpretation theory and method, establish an independent theory and method fundamentally on the basis of the change rate of pressure of a reservoir within equal time, and combine the theory with the conventional Darcy percolation theory to perform parameter regression transformation by virtue of actually tested results.

During long-term research, the inventor (inventors) of the present disclosure has found, from lots of laboratory tests on pressure change regularity, oil field tests and mathematical analysis and research on well testing data, that the conduction rate of pressure of reservoir fluid is true reflection of reservoir characteristics, and the regular change characteristic of the conduction rate of pressure has formed after the wellbore reservoir stage is ended and may be represented as:

V_{PL}=(P₂−P₁)/(t₂−t₁) (1)

In formula (1), P₁ denotes pressure of reservoir fluid at the start moment t₁ within time [t₁, t₂], P₂ denotes pressure of reservoir fluid at the end moment t₂ within time [t₁, t₂], and V_{PL} denotes a conduction rate of pressure (hereinafter referred to as pressure rate).

According to the above test results, the embodiments of the present disclosure perform lots of percolation tests and pressure conductivity tests on rock ores under different lithologic conditions. It is proved that the pressure rate of rocks changes with the change of reservoir characteristics, the change characteristic of the pressure rate has a regular change characteristic both in the Darcy flow state and the non-Darcy flow state, and the change of flow phase is often reflected as the increase or decrease of the pressure rate in the aspect of the pressure rate characteristic. However, the time when the regular change of the isochron rate established after processing the reservoir pressure rate at equal time intervals appears is much earlier than that of the radial flow state. After the wellbore reservoir stage is ended, the isochron rate forms a regular change characteristic which may be represented as:

V_{P}=(P₂−P₁)/t (2)

In formula (2), Vₚ denotes a pressure rate of reservoir fluid within a constant duration t (hereinafter referred to as isochron rate) and may truly reflect the reservoir characteristics; t may be represented as t₂−t₁, P₁ denotes pressure of reservoir fluid at the start moment t₁ within the constant duration t, and P₂ denotes pressure of reservoir fluid at the end moment t₂ within the constant duration t. The theory represented by the formula (2) may be called as an isochron rate interpretation theory in the present disclosure, is the research result of the well testing interpretation basic theory and method, and may reflect reservoir percolation characteristics.

The early regular change characteristic of the isochron rate and the regular change characteristic of the isochron rate along with flow phase make the early linear regression solution using the isochron rate curve become true, and also make the specific analysis of non-Darcy flow have theoretical supports. The present disclosure combines the research on the isochron rate change rule with the research on reservoir characteristic parameters, performs evaluation and analysis by virtue of the regular characteristic of the isochron rate curve, and analyzes and calculates reservoir characteristic parameters by taking the regular characteristic as a model so as to acquire reservoir characteristic parameters, so that the evaluation and analysis on continued flow data are performed according to the pressure rate change of continued flow, the amount of regular pressure rate change is converted into reservoir permeability, and other reservoir characteristic parameters are solved. The isochron rate interpretation theory becomes a theoretical basis for specifically evaluating, analyzing and processing continued flow data and non-Darcy flow reservoirs.

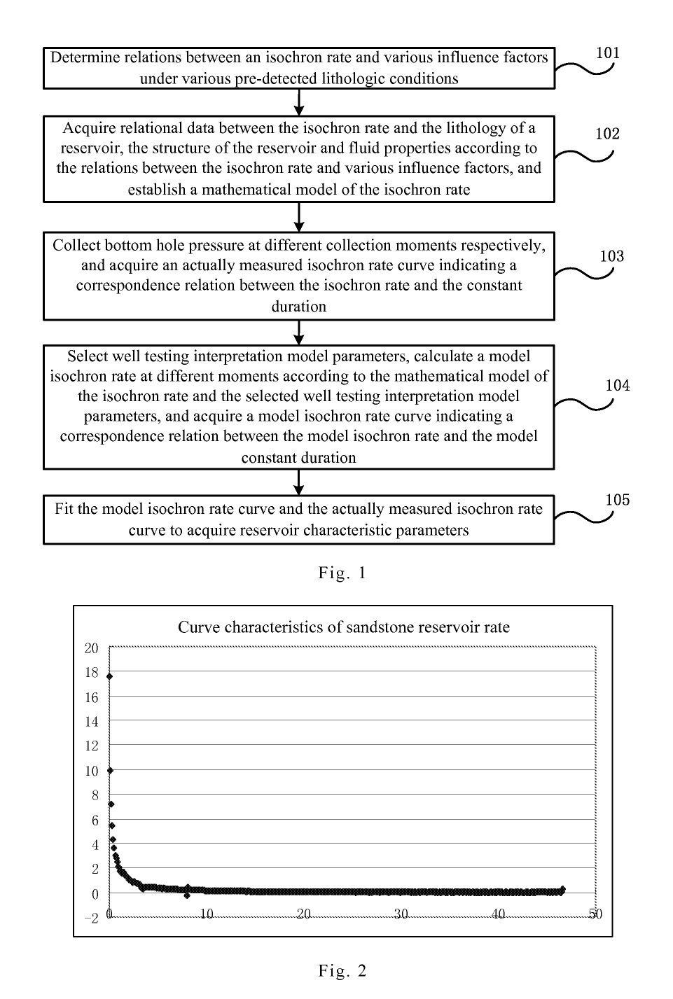

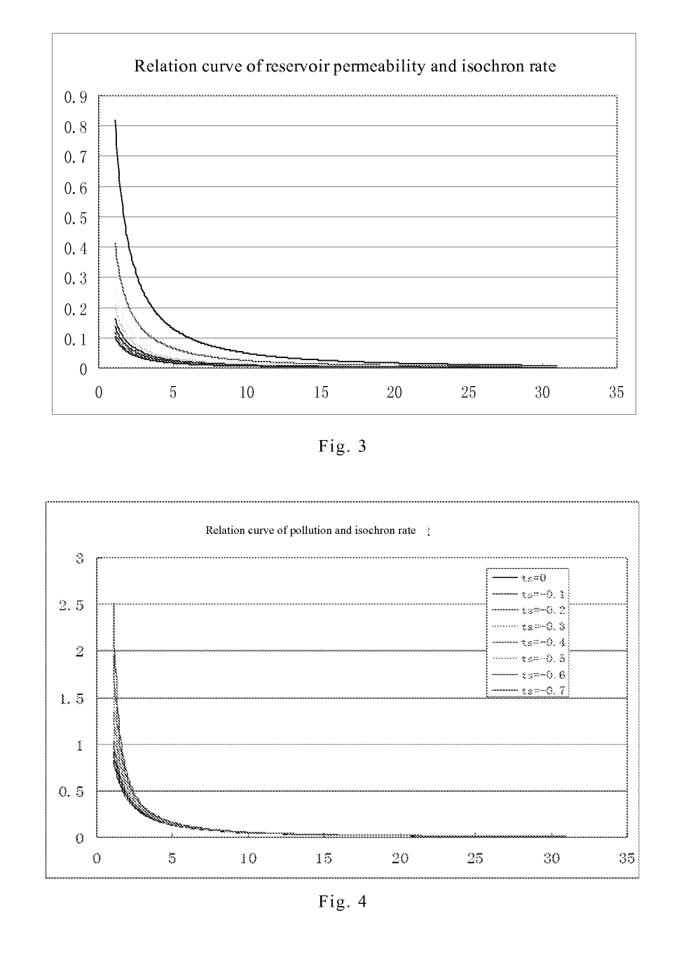

FIG. 1 is a flow diagram of an embodiment of a method for analyzing and processing continued flow data in well testing data according to the present disclosure. As shown in FIG. 1, the method for analyzing and processing continued flow data in well testing data in this embodiment includes the following steps:

Step 101, determining relations between the isochron rate and various influence factors under various pre-detected lithologic conditions, wherein the relations include a relation between the isochron rate and a percolation state, a relation between the isochron rate and permeability, a relation between the isochron rate and pollution, and a relation between the isochron rate and fracture channeling characteristics.

Step 102, acquiring relational data between the isochron rate and the lithology of a reservoir, the structure of the reservoir and fluid properties according to the relations between the isochron rate and various influence factors, and establishing a mathematical model of the isochron rate.

Step 103, during the reservoir well testing process, for example, after the wellbore reservoir stage is ended, collecting bottom hole pressure at different collection moments respectively, and acquiring a correspondence curve Vₚ˜t between the isochron rate Vₚ=(P₂−P₁)/(t₂−t₁) and the constant duration t=t₂−t₁ as an actually measured isochron rate curve.

wherein, P₂ and P₁ are pressure values collected at the end moment t₂ and the start moment t₁ of the constant duration t, respectively.

Step 104, selecting well testing interpretation model parameters conforming to the actually measured isochron rate curve, such as average production yield Q, a volume factor B of formation fluid, formation fluid viscosity U, formation fluid permeability K, channeling time t_{c}, production time tₚ and a channeling factor λ, which are approximate to the actually measured isochron rate curve, calculating a model isochron rate Vₚ′ at different moments according to the established mathematical model of the isochron rate and the selected well testing interpretation model parameters, and acquiring a correspondence curve Vₚ′˜t′ between Vₚ′ and the constant duration t′=t₂′−t₁′ as a model isochron rate curve.

wherein, Vₚ′ is an isochron rate corresponding to the model constant duration t′ acquired according to the selected well testing interpretation model parameters under the mathematical model of the isochron rate.

Step 105, fitting the model isochron rate curve and the actually measured isochron rate curve to acquire reservoir characteristic parameters including permeability K and channeling time t_{c}.

In the method for analyzing and processing continued flow data in well testing data provided by the above embodiment of the present disclosure, on the basis of researching the change rate of pressure of the reservoir within equal time, the relations between the isochron rate and various influence factors under various pre-detected lithologic conditions include a relation between the isochron rate and a percolation state, a relation between the isochron rate and permeability, a relation between the isochron rate and pollution, and a relation between the isochron rate and fracture channeling characteristics, the relational data between the isochron rate and the lithology of a reservoir, the structure of the reservoir and fluid properties is acquired according to the relations between the isochron rate and various influence factors, and the mathematical model of the isochron rate is established. Based on the isochron rate interpretation theory and method, when acquired pressure buildup or pressure drawdown data does not reach the conditions of a stable radial flow state after the wellbore reservoir stage in the well testing process is ended, bottom hole pressure at different collection times is collected respectively after the wellbore reservoir stage is ended, and an actually measured isochron rate curve indicating the relation between the isochron rate Vₚ and the constant duration t is acquired; a model isochron rate Vₚ′ at different moments is calculated according to the pre-established mathematical model of the isochron rate and the selected well testing interpretation model parameters, and a model isochron rate curve indicating the correspondence between Vₚ′ and the model constant duration t′ is acquired; then, the model isochron rate curve and the actually measured isochron rate curve are fitted to acquire reservoir characteristic parameters including permeability K and channeling time t_{c}, so that the method can be used for analyzing and processing the continued flow data, may be applied to comprehensive analysis on percolation characteristics of reservoirs within a testing radius, and can realize the interpretation processing of the continued flow data to acquire characteristic parameters of the reservoirs.

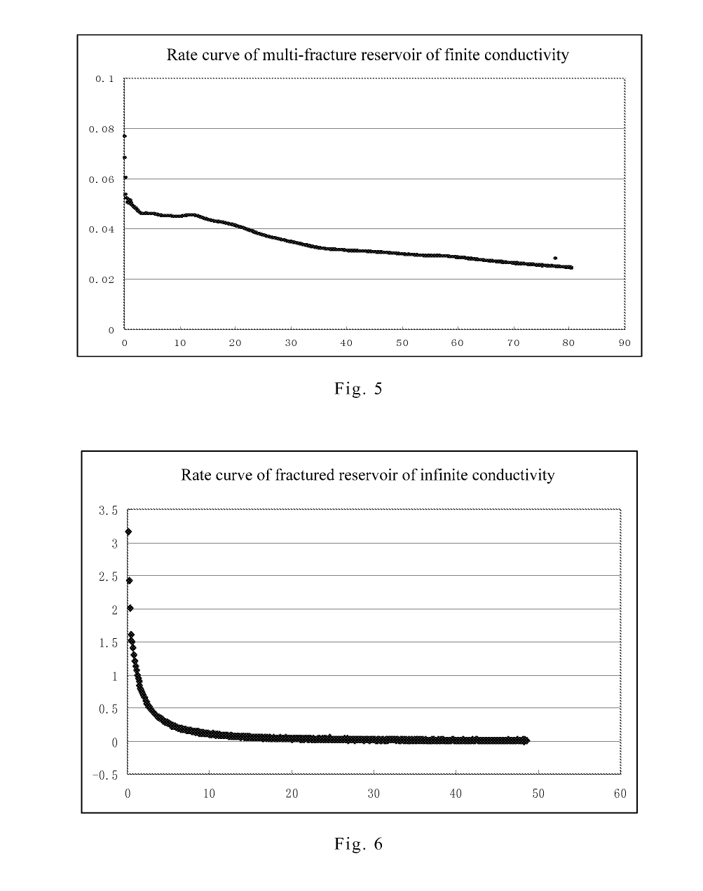

When the isochron rate interpretation theory is utilized for evaluating and analyzing continued flow data in the embodiment of the present disclosure, with respect to the correspondence between isochron rate change characteristics and reservoir characteristics, a typical isochron rate curve is established according to reservoir percolation characteristics, the relations between the isochron rate and various influence factors are established, finally, the mathematical model of the isochron rate is derived, and various characteristic parameter data of the actually measured reservoir is acquired by fitting and comparatively analyzing the actually measured isochron rate curve and the typical isochron rate curve. Through lots of laboratory rock percolation tests, the inventor (inventors) comprehensively detects the relations between the isochron rate and various influence factors under various lithologic conditions so as to acquire the relational data λQBu/Kh between the isochron rate and the lithology of a reservoir, the structure of the reservoir and fluid properties, where λ denotes a channeling factor of formation fluid, and is a preset constant more than 0, Q denotes average production yield, B denotes a volume factor of formation fluid, u denotes formation fluid viscosity, K denotes the permeability of a reservoir, h denotes the thickness of a reservoir, and the λ, Q, B, u, K and h all are dimensionless physical quantities. FIGS. 2˜6 show a schematic diagram of the relation between the isochron rate and the lithology characteristic of a reservoir, a schematic diagram of the relation between the isochron rate and permeability, a schematic diagram of the relation between the isochron rate and pollution characteristics, a schematic diagram of the relation between the isochron rate and fracture interference of finite conductivity, and a schematic diagram of the relation between the isochron rate and fracture interference of infinite conductivity in turn, wherein the fracture interference of finite conductivity and the fracture interference of infinite conductivity shown in FIG. 5 and FIG. 6 belong to facture channeling characteristics. In FIGS. 2˜6, the horizontal coordinates represent time while the vertical coordinates represent the isochron rate.

In the embodiment of the present disclosure, by analyzing influences of the lithology characteristics of reservoirs, permeability, pollution characteristics and facture channeling characteristics on the isochron rate, the following mathematical models of the isochron rate are established:

[symbol]

²V_{P}/ [symbol] r_{d}²+(1/r_{d})( [symbol] V_{P}/ [symbol] r_{d})=( [symbol] V_{P}/ [symbol] t_{d}) (3)

Vₚ=λQBu[lg(((t₂(tₚ+t₁))/((t₁(tₚ+t₂)))]/(t₂−t₁)/kh (4)

In formulae (3) and (4), Vₚ denotes a model isochron rate, t₁ denotes a start moment t₁′ of constant duration t′, t₂ denotes an end moment of the constant duration t′, tₚ denotes production time, Q denotes average production yield and is a predicted value, B denotes a volume factor of formation fluid and is a predicted value, u denotes the viscosity of formation fluid and is a predicted value, K denotes the permeability of a reservoir, h denotes the thickness of the reservoir and may be pre-measured, and λ denotes a channeling factor of formation fluid and is a preset correction constant more than 0 and is relevant to the lithology and flow conductivity characteristics of the reservoir. The above physical quantities all are dimensionless physical quantities. The flow conductivity characteristic is a general name of a flow conduction way under lithology and fluid characteristic conditions.

According to but not limited to a specific example of the method for analyzing and processing continued flow data in well testing data in the present disclosure, the value of the channeling factor λ is preset as 1.81˜2.59 according to the medium type of the reservoir and the channeling time t_{c}.

In the embodiments of the present disclosure, when the isochron rate interpretation theory is utilized to evaluate and analyze the continued flow data and non-Darcy flow data, the reservoirs is classified into a single-medium percolation (homogeneous) reservoir and a multi-medium percolation (heterogeneous) reservoir.

The single-medium percolation reservoir has wellbore storage characteristics, homogeneity, uniform thickness and infinite reservoir characteristics. The rock elastic compression of the reservoir accords with the Hooke's law, and the reservoir has balanced pressure at all points and constant production yield. The mathematical model of the isochron rate of a single-medium percolation reservoir provided by the embodiment of the present disclosure is:

[symbol]

²V_{P}/ [symbol] r_{d}²+(1/r_{d})( [symbol] V_{P}/ [symbol] r_{d})=( [symbol] V_{P}/ [symbol] t_{d}) (5)

[symbol]

²V_{P}/ [symbol] r_{d}²+(1/r_{d})( [symbol] V_{P}/ [symbol] r_{d})=(λΦ [symbol] C_{D} [symbol] V_{P}/3.6K [symbol] t) (6)

The boundary condition is V_{P}(r,t−ts)=V_{Po},V_{P}(ω,t−ts)=0 (7)

In formulae (5)˜(7), r_{d} denotes a dimensionless test radius of reservoir fluid, t_{d} denotes dimensionless percolation time and is a predicted value, [symbol] denotes the viscosity of formation fluid and is a predicted value, C_{D} denotes a total compression coefficient of formation and is a predicted value, and V_{Po} denotes a dimensionless isochron rate and is a predicted value.

According to the mathematical model of the isochron rate of a single-medium percolation reservoir and the boundary condition, the isochron rate equation of a single-medium percolation reservoir may be derived as the following formula (4):

V_{P}=λQBu[lg(((t₂(t_{P}+t₁))/((t₁(t_{P}+t₂)))/(t₂−t₁)]/Khₒ

It is proved by lots of tests that a relation between the isochron rate of a reservoir and the percolation characteristic is manifested as that in the case of using the isochron rate as an analysis precondition, the percolation process of a reservoir is directly restricted by the reservoir fluid characteristic, production pressure differential and the permeability of the reservoir, and is a direct reflection of the reservoir characteristics. During the testing well opening process, the well opening flow process of a single-medium percolation reservoir is divided into three processes, i.e., a process of medium flow, a process of medium to wellbore flow and a process of wellbore flow; the flow dynamics of shut in well is medium to wellbore flow at the beginning of shut in well. During the testing well opening process, the artificially established production pressure differential will form different percolation characteristics. When the well opening time is long, the wellbore flow pressure and the medium pressure decrease regularly, and the isochron rate changes regularly.

When the well opening time is too short, the artificially established production pressure differential is not balanced, a difference is formed between the wellbore and the medium pressure of near well bore and the medium pressure of remote well bore, and the isochron rate regularly changes in form of nonlinear flow at the beginning of shut in well within a short time, and then regularly changes in form of linear flow after entering continued flow. When the wellbore pressure forms a regular difference with the medium pressure of near well bore and the medium pressure of remote well bore, the synchronous morphology of the medium flow and the medium to wellbore flow is gradually formed in a flowing manner and indicates the finish of the wellbore storage process, the reservoir enters an equal rate change process, and the isochron rate regularly changes in form of linear flow and has the characteristic manifestations of the reservoir itself.

Therefore, for a single-medium percolation reservoir, when the fluid flow time is relatively long during the well opening process, the flow of fluid reaches a linear flow state, the percolation characteristic accords with the isochron rate equation, and it is appropriate to use the isochron rate equation to analyze and research the reservoir. When the well opening time is too short, the flow does not reach the linear flow state, and the percolation characteristic does not accord with the isochron rate equation. However, after wellbore storage, the percolation characteristic accords with the isochron rate equation.

For a multi-medium percolation reservoir, the well opening flow process is divided into five stages of porous flow, fracture seepage, fracture channeling, fracture to wellbore channeling and wellbore flow, and the flow dynamics of shut in well includes the following stages: pore (or crack) to wellbore and facture seepage at the beginning of shut in well, wherein the isochron rate regularly changes in form of nonlinear flow; a fracture seepage stage when the pressure of the wellbore and facture reaches pore (or crack) or micro-facture pressure, wherein the isochron rate regularly changes in form of fracture linear flow; a porous flow stage when the crack pressure reaches pore pressure around a crack, wherein the isochron rate regularly changes in form of porous linear flow. For a facture reservoir having a matrix without reservoir condition, there is no a late porous linear flow stage. Regardless of the wellbore storage stage, the continued flow state or the radial flow stage, the isochron rate depends on the magnitude of a flow driving force (i.e., flow pressure differential), and always regularly changes relative to the flow driving force. The reservoir percolation characteristic is a direction reflection of the true reservoir flow capability, and the pressure rate is a direct reflection of the reservoir percolation capability. During the implementation of the present disclosure, the inventor (inventors) finds that although the percolation characteristic is not the same as the pore percolation characteristic after the fracture reservoir enters a crack flow state, the change of rate is consistent with that of the pore reservoir, shows linear flow characteristics and accords with a pressure buildup isochron rate equation. As the pressure buildup is influenced by nonlinear fracture channeling, the actually measured pressure value is far larger than the linear flow pressure value within the same time, and the time of pressure buildup is influenced. In this embodiment of the present disclosure, this time is called as channeling time and represented as t. Therefore, the actually measured pressure value of a fractured reservoir is the sum of the pore percolation model pressure time t and the channeling time t. Hence, the isochron rate equation of a fractured reservoir is deduced as:

V_{P}=λQBu[lg((((t₂+t_{c})(t_{P}+t₁+t_{c}))/(((t₁+t_{c})(t_{P}+t₂+t_{c})))]/(t₂−t₁)/Kh (8)

P₂−P₁=λQBu[lg((((t₂+t_{c})(t_{P}+t₁+t_{c}))/(((t₁+t_{c})(t_{P}+t₂+t_{c})))]/Kh (9)

It is known from reservoir damage analysis tests that in the aspect of reservoir permeability, whatever pollution is reflected as the reduction of effective permeability. The pollution reduces flow conductivity and pressure conductivity of a reservoir, so that the actually measured pressure value within unit time in the presence of pollution is less than the value of pressure measured without pollution during the pressure buildup process. That is, the time required for measuring the pressure of an unpolluted reservoir after the reservoir is polluted is longer than the original time. The time difference is defined as tₛ. The measured pressure value is acquired by subtracting t (the specific value of t may be less than or equal to 0) from the theoretical time. Hence, the isochron rate equation after a reservoir is polluted is:

V_{P}=λQBu[lg((((t₂+t_{c}−t_{S}))/(((t₁+t_{c}t_{S})(t_{P}+t₂+t_{c}−t_{S})))]/(t₂−t₁)/Kh (10)

P₂−P₁=λQBu[lg((((t₂+t_{c}−t_{S})(tₚ+t₁+t_{c}−t_{S}))/(((t₁+t_{c}−t_{S})(t_{P}+t₂+t_{c}−t_{S})))]/Kh (11)

The above formulae (8) and (10) are isochron rate equations of a multi-medium percolation reservoir according to the mathematical model of the isochron rate, wherein t_{c} denotes the channeling time caused by a fractured reservoir, and tₛ denotes a difference between the time required for measuring the pressure of an unpolluted reservoir after the reservoir is polluted and the time required for measuring the pressure of an unpolluted reservoir when the reservoir is not polluted. Particularly, in the formula (10), t₁ and t₂ denotes shut-in point moments, and t₂−t₁ denotes total shut-in time. In the formula (10), the isochron rate equation of a single-medium percolation reservoir is acquired when the values of t_{c} and tₛ are 0. For a multi-medium percolation reservoir, the channeling time acquired by the embodiment of the present disclosure is equivalent channeling time for indicating the pollution characteristic, namely the equivalent channeling time t_{c}=t_{c}−tₛ acquired by the embodiment of the present disclosure.

In practical application, the pollution time Ts may be automatically calculated by the slope of the isochron rate curve. In the embodiment of the present disclosure, by changing λ and t_{c} in the above isochron rate equation, typical isochron rate curve models of a single-medium percolation reservoir and a multi-medium percolation reservoir under different lithology, fluid and percolation characteristic conditions may be established, so that the requirements of the evaluation and analysis of continued flow data and non-Darcy flow reservoirs are met.

In the above formulae of the present disclosure, Vₚ is a model isochron rate Vₚ′, and t₂ and t₁ are an end moment t₂′ and a start moment t₁′ of the model constant duration t′.

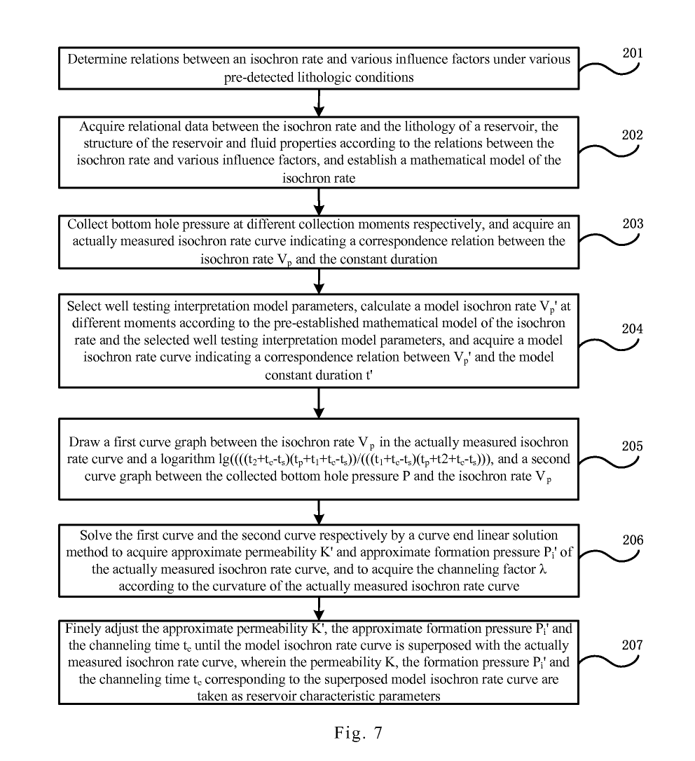

FIG. 7 is a flow diagram of another embodiment of a method for analyzing and processing continued flow data in well testing data according to the present disclosure. As shown in FIG. 7, the method for analyzing and processing continued flow data in well testing data provided in this embodiment includes the following steps:

Step 201, determining relations between the isochron rate and various influence factors under various pre-detected lithologic conditions, wherein the relations comprise a relation between the isochron rate and a percolation state, a relation between the isochron rate and permeability, a relation between the isochron rate and pollution, and a relation between the isochron rate and fracture channeling characteristics.

Step 202, acquiring relational data between the isochron rate and the lithology of a reservoir, the structure of the reservoir and fluid properties according to the relations between the isochron rate and various influence factors, and establishing a mathematical model of the isochron rate.

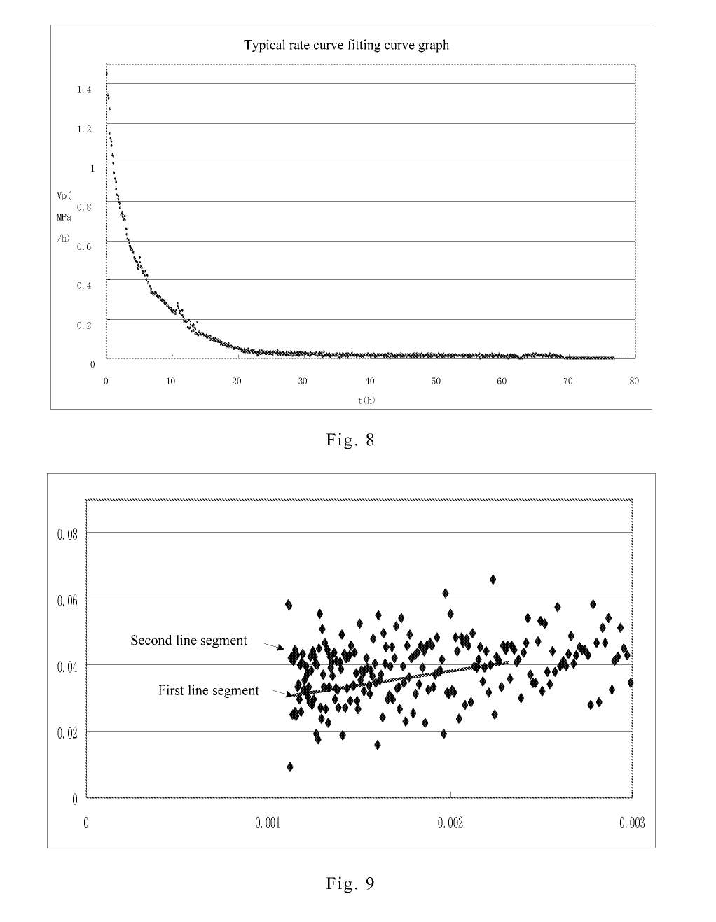

Step 203, during the reservoir well testing process, for example, after the wellbore reservoir stage is ended, collecting bottom hole pressure at different collection moments respectively, and acquiring a correspondence curve Vₚ˜t between the isochron rate Vₚ=(P₂−P₁)/(t₂−t₁) and the constant duration t=t₂−t₁ as an actually measured isochron rate curve.

wherein P₂ and P₁ are pressure values collected at the collection moments t₂ and t₁, respectively, and FIG. 8 is a specific example of the curve Vₚ˜t in this embodiment of the present disclosure.

Step 204, selecting well testing interpretation model parameters conforming to the actually measured isochron rate curve, calculating a model isochron rate Vₚ′ at different moments according to the pre-established isochron rate equation and the selected well testing interpretation model parameters, and acquiring a correspondence curve Vₚ′˜t′ between Vₚ′ and the model constant duration t′=t₂′−t₁′ as a model isochron rate curve.

Wherein Vₚ′ is an isochron rate corresponding to the model constant duration t′ acquired according to the selected well testing interpretation model parameters under the mathematical model of the isochron rate; t₁ and t₂ in the isochron rate equation denote a start point and an end point of the constant duration, respectively, and t₁′ and t₂′ are a start point and an end point of the constant duration represented by the model, respectively; when the model isochron rate is calculated according to the isochron rate equation, t₁′ and t₂′ are t₁ and t₂ in the isochron rate equation, respectively, and the calculated Vₚ is Vₚ′; the meaning of distinguishing t₁′ from t₁, t₂′ from t₂, and Vₚ′ from Vₚ is that the specific values of the both may be identical or different.

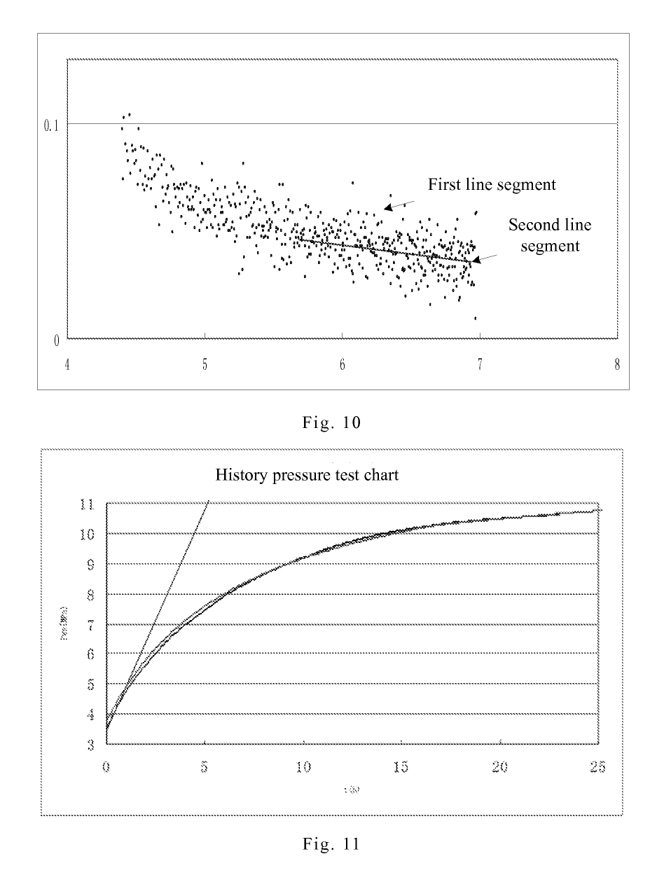

Step 205, drawing a first curve graph of the isochron rate Vₚ in the actually measured isochron rate curve and a logarithm lg((((t₂+t_{c}−tₛ)(tₚ+t₁+t_{c}−tₛ))/(((t₁+t_{c}−tₛ)(tₚ+t₂+t_{c}-tₛ))), and drawing a second curve graph of the collected bottom hole pressure p and the isochron rate Vₚ.

Wherein FIG. 9 is a specific example of the first curve graph according to the embodiment of the present disclosure, wherein the vertical coordinate represents the isochron rate Vₚ, and the horizontal coordinate represents the logarithm lg((((t₂+t_{c}−tₛ)(tₚ+t₁+t_{c}−tₛ))/(((t₁+t_{c}−tₛ)(tₚ+t₂+t_{c}−tₛ))); FIG. 10 is a specific example of the second curve graph according to the embodiment of the present disclosure, wherein the vertical coordinate represents the isochron rate Vₚ, and the horizontal coordinate represents the bottom hole pressure p. In FIGS. 9-10, a first line segment represents a relation line corresponding to the actually measured pressure data, and a second line segment represents a straight line of a straight line segment at the tail end of the curve.

Step 206, solving the first curve and the second curve by a curve end linear solution method respectively, namely acquiring approximate permeability K′ of the actually measured isochron rate curve by solving the linear slope at the tail end of the first curve, acquiring approximate formation pressure Pᵢ′ by solving the linear slope at the tail end of the second curve, and acquiring a channeling factor λ according to the curvature of the actually measured isochron rate curve, for example, according to V_{P}=0.001858λQBu/Kh, the value of the channeling factor λ may be acquired in the case of other parameter values being known.

Step 207, finely adjusting the approximate permeability K′, the approximate formation pressure Pᵢ′ and the equivalent channeling time t_{c}−tₛ until the model isochron rate curve is superposed with the actually measured isochron rate curve, wherein the permeability K, the formation pressure Pᵢ and the equivalent channeling time t_{c}−tₛ corresponding to the superposed model isochron rate curve are used as the reservoir characteristic parameters.

After the reservoir characteristic parameters are acquired by the method for analyzing and processing continued flow data in this embodiment of the present disclosure, the actually measured curve P˜t indicating the relation between the bottom hole pressure P collected at different collection moments and a collection moment t may be further drawn. FIG. 11 is a specific example of the actually measured curve P˜t according to the embodiment of the present disclosure. The model curve P˜t is drawn according to the acquired reservoir characteristic parameters by the formula (11), and it is compared to determine whether the actually measured curve P˜t is totally fitted (i.e., superposed) with the model curve P˜t. If the actually measured curve P˜t is not totally superposed with the model curve P˜t, the reservoir characteristic parameters may be further adjusted to totally fit the actually measured curve P˜t with the model curve P˜t so as to acquire reservoir characteristic parameters more accurately.

In the embodiment of the present disclosure, according to whether the actually measured curve P˜t is totally superposed with the model curve P˜t or not, formation pressure Pᵢ may be acquired, and it may also be analyzed to judge whether models of the model isochron rate curve and the actually measured isochron rate curve in fitting are consistent. Only when the model isochron rate curve is consistent with the actual type of formation, the morphologies of the actually measured curve P˜t and the model curve P˜t may be totally consistent, and the result of fitting the model isochron rate curve with the actually measured isochron rate curve is correct. Otherwise, related well testing interpretation model parameters of the model isochron rate curve need to be further adjusted.

After the reservoir characteristic parameters are acquired by the method for analyzing and processing continued flow data in well testing data provided by the embodiment of the present disclosure, other reservoir characteristic parameters may be further acquired based on these reservoir characteristic parameters according to a further embodiment of the method for analyzing and processing continued flow data in well testing data of the present disclosure. For example, a testing radius r_{d} of reservoir fluid is calculated and acquired by the total shut-in time and the well opening production time tₚ; an abnormal outlier distance and a fracture half length are calculated based on the channeling time t_{c}; the channeling factor λ is calculated and acquired based on the permeability K and the predicted matrix permeability K1; the formation factor KH and the flow factor KH/u are calculated by the permeability K.

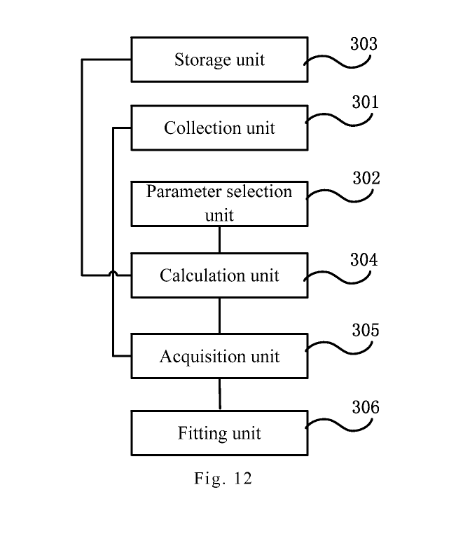

FIG. 12 is a structure diagram of an embodiment of a system for analyzing and processing continued flow data in well testing data according to the present disclosure. The analysis and processing system in this embodiment may be used for implementing the flow of the above analysis and processing methods of the present disclosure. As shown in FIG. 12, the system includes a collection unit 301, a parameter selection unit 302, a storage unit 303, a calculation unit 304, an acquisition unit 305 and a fitting unit 306.

The collection unit 301 is configured to collect bottom hole pressure at different collection moments respectively during the reservoir well testing process, for example, after a wellbore reservoir stage is ended.

The parameter selection unit 302 is configured to select well testing interpretation model parameters.

The storage unit 303 is configured to store a pre-established mathematical model of an isochron rate. The mathematical model of the isochron rate is established on the basis of relational data between the isochron rate and the lithology of a reservoir, the structure of the reservoir and fluid properties, which is obtained by relations between the isochron rate and various influence factors under various pre-detected lithologic conditions. The relations between the isochron rate and various influence factors include a relation between the isochron rate and a percolation state, a relation between the isochron rate and permeability, a relation between the isochron rate and pollution, and a relation between the isochron rate and fracture channeling characteristics.

Exemplarily, a mathematical model of the isochron rate is established on the basis of relational data between the isochron rate and the lithology of a reservoir, the structure of the reservoir and fluid properties, which is obtained by relations between the isochron rate and various influence factors under various pre-detected lithologic conditions. The relations between the isochron rate and various influence factors include a relation between the isochron rate and a percolation state, a relation between the isochron rate and permeability, a relation between the isochron rate and pollution, and a relation between the isochron rate and fracture channeling characteristics, wherein the relation between the isochron rate and the fracture channeling characteristics includes a relation between the isochron rate and fracture interference of finite conductivity, and a relation between the isochron rate and fracture interference of infinite conductivity.

The calculation unit 304 is configured to calculate a model isochron rate Vₚ′ at different moments according to the well testing interpretation model parameters selected by the parameter selection unit 302 and the mathematical model of the isochron rate stored in the storage unit 303, wherein Vₚ′ is an isochron rate corresponding to the model constant duration t′ acquired according to the selected well testing interpretation model parameters under the mathematical model of the isochron rate.

The acquisition unit 305 is configured to acquire a correspondence curve Vₚ˜t between the isochron rate Vₚ=(P₂−P₁)/(t₂−t₁) and the constant duration t=t₂−t₁ as an actually measured isochron rate curve according to the bottom hole pressure at different collection moments collected by the collection unit 301, wherein P₂ and P₁ are pressure values collected at the end moment t₂ and the start moment t₁ of the constant duration t. The acquisition unit 305 is also configured to acquire a correspondence curve Vₚ′˜t′ between the model isochron rate Vₚ′ and the model constant duration t′=t₂′−t₁′ calculated by the calculation unit 304 as a model isochron rate curve.

The fitting unit 306 is configured to fit the model isochron rate curve and the actually measured isochron rate curve acquired by the acquisition unit 305 to acquire reservoir characteristic parameters including permeability K and channeling time t_{c}.

In the system for analyzing and processing continued flow data in well testing data provided by the above embodiment of the present disclosure, on the basis of researching the change rate of pressure of a reservoir within equal time and on the basis of an isochron rate interpretation theory and method, when the acquired pressure buildup or pressure drawdown data does not reach the conditions of a stable radial flow state after the wellbore reservoir stage in the well testing process is ended, bottom hole pressure at different collection times is collected respectively after the wellbore reservoir stage is ended, an actually measured isochron rate curve indicating the relation between the isochron rate Vₚ and the constant duration t is acquired, a model isochron rate Vₚ′ at different model moments is calculated according to the pre-established mathematical model of the isochron rate and the selected well testing interpretation model parameters, a model isochron rate curve indicating the correspondence between Vₚ′ and the model constant duration t is acquired, and then, the model isochron rate curve and the actually measured isochron rate curve are fitted to acquire reservoir characteristic parameters including permeability K and channeling time t_{c}, so that the system can be used for analyzing and processing the continued flow data, may be applied to comprehensive analysis on percolation characteristics of reservoirs within a testing radius, and realizes the interpretation processing of the continued flow data to acquire characteristic parameters of the reservoirs.

According to but not limited to a specific example of the embodiment of the analysis and processing system of the present disclosure, the mathematical model of the isochron rate stored in the storage unit 303 is:

Vₚ=λQBu[lg(((t₂(tₚ+t₁))/((t₁(tₚ+t₂)))]/(t₂−t₁)/kh (4)

wherein Vₚ denotes a model isochron rate Vₚ′, t₁ denotes a start moment t₁′ of the constant duration t′, t₂ denotes an end moment t₂′ of the constant duration t′, tₚ denotes production time, Q denotes average production yield, B denotes a volume factor of formation fluid, u denotes the viscosity of formation fluid, K denotes the permeability of a reservoir, h denotes the thickness of a reservoir, and λ denotes a channeling factor of formation fluid and is a preset constant more than 0.

The value of λ is preset as 1.81˜2.59 according to the medium type of the reservoir and the channeling time t_{c}. The reservoirs may include a single-medium percolation reservoir and a multi-medium percolation reservoir in terms of medium types.

According to but not limited to another specific example of the embodiment of the analysis and processing system of the present disclosure, the storage unit 303 further includes an isochron rate equation of a single-medium percolation reservoir, which is set according to the formula (4), and is the same as the formula (4) to be specific.

In addition, the storage unit 303 further includes an isochron rate equation of a multi-medium percolation reservoir set according to the mathematical model of the isochron rate:

V_{P}=λQBu[lg((((t₂+t_{C}−t_{S})(t_{P}+t₁+t_{C}−t_{S}))/(((t₁+t_{C}−t_{S})(t_{P}+t₂+t_{C}−t_{S})))]/(t₂−t₁)/Kh (10)

wherein, t_{c} denotes the channeling time caused by a fractured reservoir, and tₛ denotes a difference between the time required for measuring the pressure of an unpolluted reservoir after the reservoir is polluted and the time required for measuring the pressure of an unpolluted reservoir when the reservoir is not polluted.

According to but not limited to another specific example of the embodiment of the analysis and processing system of the present disclosure, corresponding to the above embodiments of the analysis and processing method of the present disclosure, the calculation unit 304 may specifically calculate a model isochron rate at different moments according to the pre-established isochron rate equation and the selected well testing interpretation model parameters.

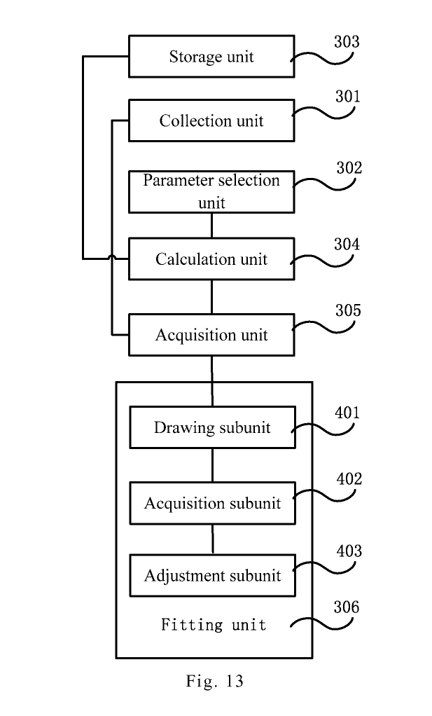

FIG. 13 is a structure diagram of another embodiment of a system for analyzing and processing continued flow data in well testing data according to the present disclosure. The analysis and processing system in this embodiment may be used for implementing the flow of the analysis and processing system method in the embodiment of the present disclosure shown in FIG. 7. Compared with the embodiment shown in FIG. 12, the fitting unit 306 in this embodiment shown in FIG. 13 specifically includes a drawing subunit 401, an acquisition subunit 402 and an adjustment subunit 403.

Wherein the drawing subunit 401 is configured to draw a first curve graph of the isochron rate Vₚ in the actually measured isochron rate curve acquired by the acquisition unit 305 and a logarithm lg((((t₂+t_{c}−tₛ)(tₚ+t₁+t_{c}−tₛ))/(((t₁+t_{c}−tₛ)(tₚ+t₂+t_{c}−tₛ))) in the isochron rate equation stored in the storage unit 303, and to draw a second curve graph of the bottom hole pressure p collected by the collection unit and the isochron rate Vₚ.

The acquisition subunit 402 is configured to solve the first curve and the second curve drawn by the drawing subunit 401 respectively by a curve end linear solution method so as to acquire approximate permeability K′ and approximate formation pressure Pᵢ′ of the actually measured isochron rate curve, and to acquire the channeling factor λ according to the curvature of the actually measured isochron rate curve.

The adjustment subunit 403 is configured to finely adjust the approximate permeability K′, the approximate formation pressure and the channeling time t_{c} acquired by the acquisition subunit 402, and to instruct the drawing subunit 402 to redraw the first curve graph and the second curve graph until the model isochron rate curve is superposed with the actually measured isochron rate curve, wherein the permeability K, the formation pressure Pᵢ and the channeling time t_{c} corresponding to the superposed model isochron rate curve are taken as the reservoir characteristic parameters.

According to but not limited to another specific example of the embodiment of the analysis and processing system of the present disclosure, other than the collection unit 301, other units in the system for analyzing and processing continued flow data in well testing data may be operably coupled into user equipment, wherein the user equipment may be a computer or other terminal equipment.

Various embodiments in the present specification may be described progressively. The highlight of each embodiment describes the difference between this embodiment and other embodiments. The identical or similar parts of the embodiments may refer to each other. As the embodiments of the system are basically corresponding to the embodiments of the method, the descriptions of the embodiments of the system are relatively simple, and the related points may refer to a part of descriptions in the embodiments of the method.

There may be many ways to implement the method and system provided by the present disclosure. For example, the method and system provided by the present disclosure may be implemented by software, hardware, firmware or any combination thereof. The order above of the steps of the method is provided just for a purpose of description, and the steps of the method of the present disclosure do not be limited to the order described above, unless otherwise specified in other ways. In addition, in some embodiments, the present disclosure may be implemented as programs recorded in a recording medium, and these programs include machine readable instructions for implementing the method provided by the present disclosure. Therefore, the present disclosure also covers a recording medium for storing programs for executing the method provided by the present disclosure.

A person of ordinary skill in the art may understand that all or a part of the steps of the foregoing embodiments of the method may be implemented by hardware related to program instructions. The programs may be stored in a computer readable storage medium. The programs execute the steps of the embodiments of the method during running. The storage medium includes an ROM, an RAM, a magnetic disk, an optical disk or other medium capable of storing program codes.

Based on the isochron rate interpretation theory and method, the embodiments of the present disclosure realize the interpretation processing to continued flow data, acquire characteristic parameters of a reservoir, and achieve the aim of analysis and processing the same as that of the radial flow data so as to perform evaluation and analysis on non-Darcy flow reservoirs.

The isochron rate interpretation theory and method provided by the embodiments of the present disclosure are an important method for analyzing and processing different reservoir types, and gives full play to the difference between its research object and conventional interpretation methods. According to an isochron rate and time change characteristic theory, with the interpretation theoretical basis as a model framework and the actually measured reservoir rate characteristics as a model establishment basis, a powerful function of automatically establishing a model with the actually measured reservoir characteristics is formed, the capability of interpreting and evaluating various types of reservoirs may be realized, and the method may be applicable to interpretation and evaluation on sandstone, carbonatite, volcanics, porous reservoirs, fractured reservoirs, diplopore reservoirs, etc.

The isochron rate interpretation theory and method provided by the embodiments of the present disclosure are established on the basis of using a percolation rate as a reservoir characteristic, and the change characteristic of the percolation rate in various percolation states during testing shows the percolation capability of the reservoir itself, thereby realizing the evaluation and analysis of continued data and the evaluation and analysis of radial flow data.

By the processing function specific to continued flow data formed by the isochron rate interpretation theory and method provided by the embodiments of the present disclosure, during low permeability reservoir testing, a user may prolong the well opening time to a largest extent, expand a sweep radius and a testing scope and understand anisotropism of a low permeability reservoir more perfectly without considering the influences of pressure drawdown to buildup time. Furthermore, in view of the problem that the yield will be influenced by too long shut-in time during the development of well testing, the user may shorten the shut-in time specifically according to the test purpose, so that a short well testing operation technology using a method for measuring continued flow data is realized, and the influence of the test to the yield of oil fields is alleviated.

The descriptions of the present disclosure are merely exemplary and illustrative, and are not exhaustive or intended to limit the present disclosure in the disclosed form. Various modifications and changes are apparent for a person of ordinary skill in the art. The selection and description of the embodiments are for better illustrating the principle and practical application of the present disclosure, and enable a person of ordinary skill in the art to understand the present disclosure so as to design various embodiments with various modifications for specific purposes.

What is claimed is:

1. A method for analyzing and processing continued flow data in well testing data, comprising:
determining relations between an isochron rate and influence factors under pre-detected lithologic conditions, wherein the relations comprise a relation between the isochron rate and a percolation state, a relation between the isochron rate and permeability, a relation between the isochron rate and pollution, and a relation between the isochron rate and fracture channeling characteristics;
acquiring relational data between the isochron rate and the lithology of a reservoir, a structure of the reservoir, and fluid properties according to the relations between the isochron rate and the influence factors;
establishing a mathematical model of the isochron rate;
collecting bottom hole pressure at different collection moments respectively during the reservoir well testing process;
acquiring a correspondence curve Vₚ˜t between the isochron rate Vₚ=(P₂−P₁)/(t₂−t₁) and the constant duration t=t₂−t₁ as a measured isochron rate curve, wherein P₂ and P₁ are pressure values collected at the end moment t₂ and the start moment t₁ of the constant duration t, respectively;
selecting well testing interpretation model parameters;
calculating a model isochron rate Vₚ′ at different moments according to the mathematical model of the isochron rate and the selected well testing interpretation model parameters;
acquiring a correspondence curve Vₚ−t between Vₚ and the model constant duration t=t₂−t₁ as a model isochron rate curve, wherein Vₚ′ is an isochron rate corresponding to the model constant duration t′ acquired according to the selected well testing interpretation model parameters under the mathematical model of the isochron rate; and
fitting the model isochron rate curve and the measured isochron rate curve to acquire reservoir characteristic parameters comprising permeability K and channeling time t_{c}.

2. The method according to claim 1, wherein that the relational data between the isochron rate and the lithology of a reservoir, the structure of the reservoir and the fluid properties is specifically λQBu/Kh;
wherein, λ denotes a channeling factor of formation fluid, and is a preset constant more than 0, Q denotes average production yield, B denotes a volume factor of formation fluid, u denotes viscosity, K denotes the permeability of a reservoir, and h denotes the thickness of a reservoir.

3. The method according to claim 2, wherein that the mathematical model of the isochron rate is:
V_{P}=λQBu[lg(((t₂(t_{P}+t₁))/((t₁(t_{P}+t₂)))/(t₂−t₁)]/Kh
wherein, Vₚ denotes a model isochron rate Vₚ′, t₁ denotes a start moment t₁′ of the constant duration t′, t₂ denotes an end moment t₂′ of the constant duration t′, tₚ denotes production time, Q denotes average production yield, B denotes a volume factor of formation fluid, u denotes the viscosity of formation fluid, K denotes the permeability of a reservoir, h denotes the thickness of a reservoir, and λ denotes a channeling factor of formation fluid and is a preset constant more than 0.

4. The method according to claim 3, wherein that the value of λ is preset as 1.81˜2.59 according to the medium type of the reservoir and the channeling time t_{c}.

5. The method according to claim 3, wherein that the reservoir comprises a single-medium percolation reservoir and a multi-medium percolation reservoir in terms of medium types.

6. The method according to claim 5, further comprising a step of:
setting, according to the mathematical model of the isochron rate, an isochron rate equation of a single-medium percolation reservoir as:
V_{P}=λQBu[lg(((t₂(t_{P}+t₁))/((t₁(t_{P}+t₂)))/(t₂−t₁)]/Khₒ

7. The method according to claim 6, wherein calculating a model isochron rate at different model moments according to the mathematical model of the isochron rate and the selected well testing interpretation model parameters comprises:
calculating a model isochron rate at different model moments according to the pre-established isochron rate equation and the selected well testing interpretation model parameters.

8. The method according to claim 7, wherein fitting the model isochron rate curve and the curve and the measured isochron rate curve to acquire reservoir characteristic parameters comprises:
drawing a first curve graph of the isochron rate Vₚ in the measured isochron rate curve and a logarithm lg((((t₂+t_{c}−tₛ)(tₚ+t₁+t_{c}−tₛ))/(((t₁+t_{c}−tₛ)(tₚ+t₂+t_{c}−tₛ))), and drawing a second curve graph of the collected bottom hole pressure P and the isochron rate Vₚ;
solving the first curve and the second curve respectively by a curve end linear solution method to acquire approximate permeability K′ and approximate formation pressure Pᵢ′ of the measured isochron rate curve, and acquiring the channeling factor λ according to the curvature of the measured isochron rate curve; and
finely adjusting the approximate permeability K′, the approximate formation pressure Pᵢ′ and the channeling time t, until the model isochron rate curve is superposed with the measured isochron rate curve, wherein the permeability K, the formation pressure Pᵢ and the channeling time t_{c} corresponding to the superposed model isochron rate curve are taken as the reservoir characteristic parameters.

9. The method according to claim 5, further comprising
setting, according to the mathematical model of the isochron rate, an isochron rate equation of a multi-medium percolation reservoir as:
V_{P}=λQBu[lg((((t₂+t_{c}−t_{S})(t_{P}+t₁+t_{c}−t_{S}))/(((t₁+t_{c}−t_{S})(t_{P}+t₂+t_{c}−t_{S})))]/(t₂−t₁)/Kh;
wherein t_{c} denotes channeling time caused by a fractured reservoir, and tₛ denotes a difference between the time required for measuring the pressure of an unpolluted reservoir after the reservoir is polluted and the time required for measuring the pressure of an unpolluted reservoir when the reservoir is not polluted.

10. The method according to claim 9, wherein that calculating a model isochron rate at different model moments according to the mathematical model of the isochron rate and the selected well testing interpretation model parameters comprises:
calculating a model isochron rate at different model moments according to the pre-established isochron rate equation and the selected well testing interpretation model parameters.

11. The method according to claim 8, wherein that fitting the model isochron rate curve and the measured isochron rate curve to acquire reservoir characteristic parameters comprises:
drawing a first curve graph of the isochron rate Vₚ in the measured isochron rate curve and a logarithm lg((((t₂+t_{c}−tₛ)(tₚ+t₁+t_{c}−tₛ))/(((t₁+t_{c}−tₛ)(tₚ+t₂+t_{c}−tₛ))), and drawing a second curve graph of the collected bottom hole pressure P and the isochron rate Vₚ;
solving the first curve and the second curve respectively by a curve end linear solution method to acquire approximate permeability K′ and approximate formation pressure Pᵢ′ of the measured isochron rate curve, and acquiring the channeling factor λ according to the curvature of the measured isochron rate curve; and
finely adjusting the approximate permeability K′, the approximate formation pressure Pᵢ′ and the channeling time t, until the model isochron rate curve is superposed with the measured isochron rate curve, wherein the permeability K, the formation pressure Pᵢ and the channeling time t_{c} corresponding to the superposed model isochron rate curve are taken as the reservoir characteristic parameters.

12. A system for analyzing and processing continued flow data in well testing data, comprising:
a collection unit configured to collect bottom hole pressure at different collection moments respectively during the reservoir well testing process;
a parameter selection unit configured to select well testing interpretation model parameters;
a storage unit configured to store a pre-established mathematical model of an isochron rate, wherein the mathematical model of the isochron rate is established on the basis of relational data between the isochron rate and the lithology of a reservoir, the structure of the reservoir and fluid properties, which are obtained by relations between the isochron rate and influence factors under pre-detected lithologic conditions, and the relations between the isochron rate and the influence factors comprise a relation between the isochron rate and a percolation state, a relation between the isochron rate and permeability, a relation between the isochron rate and pollution, and a relation between the isochron rate and fracture channeling characteristics;
a calculation unit configured to calculate a model isochron rate Vₚ′ at different moments according to the well testing interpretation model parameters selected by the parameter selection unit and the mathematical model of the isochron rate stored in the storage unit, wherein Vₚ′ is an isochron rate corresponding to the model constant duration t′ acquired according to the selected well testing interpretation model parameters under the mathematical model of the isochron rate;
an acquisition unit configured to acquire a correspondence curve Vₚ−t between the isochron rate Vₚ=(P₂−P₁)/(t₂−t₁) and the constant duration t=t₂−t₁ as a measured isochron rate curve according to the bottom hole pressure collected at different collection moments respectively by the collection unit, and to acquire a correspondence curve Vₚ′−t′ between the model isochron rate Vₚ′ calculated by the calculation unit and the model constant duration t=t₂′−t₁′, wherein P₂ and P₁ are pressure values collected at the end moment t₂ and the start moment t₂ of the constant duration t; and
a fitting unit configured to fit the model isochron rate curve and the measured isochron rate curve acquired by the acquisition unit to acquire reservoir characteristic parameters comprising permeability K and channeling time t_{c}.

13. The system according to claim 12, wherein that the mathematical model of the isochron rate is:
V_{P}=λQBu[lg(((t₂(t_{P}+t₁))/((t₁(t_{P}+t₂)))/(t₂−t₁)]/Kh;
wherein Vₚ denotes a model isochron rate Vₚ′, t₁′ denotes a start moment t₁′ of the constant duration t′, t₂ denotes an end moment t₂′ of the constant duration t′, tₚ denotes production time, Q denotes average production yield, B denotes a volume factor of formation fluid, u denotes the viscosity of formation fluid, K denotes the permeability of a reservoir, h denotes the thickness of a reservoir, and λ denotes a channeling factor of formation fluid and is a preset constant more than 0.

14. The system according to claim 13, wherein that the value of is preset as 1.81˜2.59 according to the medium type of the reservoir and the channeling time t_{c}.

15. The system according to claim 13, wherein that the reservoir comprises a single-medium percolation reservoir and a multi-medium percolation reservoir in terms of medium type.

16. The system according to claim 15, wherein that the storage unit further comprises an isochron rate equation of a single-medium percolation reservoir set according to the mathematical model of the isochron rate:
V_{P}=λQBu[lg(((t₂(t_{P}+t₁))/((t₁(t_{P}+t₂)))/(t₂−t₁)]/Khₒ

17. The system according to claim 16, wherein that the calculation unit is specifically used for calculating a model isochron rate at different model moments according to the established isochron rate equation and the selected well testing interpretation model parameters.

18. The system according to claim 17, wherein that the fitting unit comprises:
a drawing subunit configured to draw a first curve graph between the isochron rate Vₚ in the measured isochron rate curve acquired by the acquisition unit and a logarithm lg((((t₂+t_{c}−tₛ)(tₚ+t₁+t_{c}−tₛ))/(((t₁+t_{c}−tₛ)(tₚ+t₂+t_{c}−tₛ))) in the isochron rate equation stored in the storage unit, and to draw a second curve graph of the bottom hole pressure p collected by the collection unit and the isochron rate Vₚ;
an acquisition subunit configured to solve the first curve and the second curve respectively by a curve end linear solution method, acquire approximate permeability K′ and approximate formation pressure Pᵢ′ of the measured isochron rate curve, and acquire the channeling factor λ according to the curvature of the measured isochron rate curve; and
an adjustment subunit configured to finely adjust the approximate permeability K′, the approximate formation pressure Pᵢ′ and the channeling time t_{c} acquired by the acquisition subunit, and to instruct the drawing subunit to redraw the first curve graph and the second curve graph until the model isochron rate curve is superposed with the measured isochron rate curve, wherein the permeability K, the formation pressure Pᵢ and the channeling time t, corresponding to the superposed model isochron rate curve are taken as the reservoir characteristic parameters.

19. The system according to claim 15, wherein that the storage unit further comprises an isochron rate equation of the multi-medium percolation reservoir set according to the mathematical model of the isochron rate:
V_{P}=λQBu[lg((((t₂+t_{c}−t_{S})(t_{P}+t₁+−t_{S}))/(((t₁+t_{c}−t_{S})(t_{P}+t₂+t_{c}−t_{S})))]/(t₂−t₁)/Kh;
wherein t_{c} denotes channeling time caused by a fractured reservoir, and tₛ denotes a difference between the time required for measuring the pressure of an unpolluted reservoir after the reservoir is polluted and the time required for measuring the pressure of an unpolluted reservoir when the reservoir is not polluted.

20. The system according to claim 19, wherein that the calculation unit is specifically used for calculating a model isochron rate at different model moments according to the established isochron rate equation and the selected well testing interpretation model parameters.

21. The system according to claim 20, wherein that the fitting unit comprises:
a drawing subunit configured to draw a first curve graph between the isochron rate Vₚ in the measured isochron rate curve acquired by the acquisition unit and a logarithm lg((((t₂+t_{c}−tₛ)(tₚ+t₁+t_{c}−tₛ))/(((t₁+t_{c}−tₛ)(tₚ+t₂+t_{c}−tₛ))) in the isochron rate equation stored in the storage unit, and to draw a second curve graph of the bottom hole pressure p collected by the collection unit and the isochron rate Vₚ;
an acquisition subunit configured to solve the first curve and the second curve respectively by a curve end linear solution method, acquire approximate permeability K′ and approximate formation pressure Pᵢ′ of the measured isochron rate curve, and acquire the channeling factor λ according to the curvature of the measured isochron rate curve; and
an adjustment subunit configured to finely adjust the approximate permeability K′, the approximate formation pressure Pᵢ′ and the channeling time t_{c} acquired by the acquisition subunit, and to instruct the drawing subunit to redraw the first curve graph and the second curve graph until the model isochron rate curve is superposed with the measured isochron rate curve, wherein the permeability K, the formation pressure Pᵢ and the channeling time t_{c} corresponding to the superposed model isochron rate curve are taken as the reservoir characteristic parameters.

22. The system according to claim 12, wherein that other than the collection unit, other units in the system for analyzing and processing continued flow data in well testing data may be operably coupled into user equipment.
